(19) United States
(12) Patent Application Publication
(10) Pub. No.: US 2011/0030187 A1
(43) Pub. Date: Feb. 10, 2011

(54) Pool Skimmer Accessory System

(76) Inventor: Peter Bongiorno, Chandler, AZ (US)

Correspondence Address: JAY M. SCHLOFF, 6960 Orchard Lake Road, Suite 315, West Bloomfield, MI, 48322, US

(21) Appl. No.: 12/851,339

(22) Filed: Aug. 5, 2010

Related U.S. Application Data
(60) Provisional application No. 61/231,384, filed on Aug. 5, 2009.

(51) Int. Cl. B23P 19/00

(52) U.S. Cl. 29/426.2

(57) ABSTRACT

A pool skimmer accessory system comprises a skimmer accessory for enabling the removal and replacement of a pool skimmer cover and retrieval of a skimmer from a pool skimmer chamber. The skimmer accessory includes an elongate shaft member with a handle portion disposed at a first end thereof and a tapered region disposed at a second end thereof. Disposed in or adjacent to the tapered region is a cut-out section that extends toward the interior of the shaft member. The accessory allows a user to access a pool skimmer and skimmer cover from a safe distance such that the user is not directly subjected to debris or dangerous insects or animals that may be concealed under the skimmer cover.

### CROSS REFERENCE TO RELATED APPLICATIONS

The present application claims priority under United States Code §119 on the U.S. Provisional Patent Application Ser. No. 61/231,384, filed on Aug. 5, 2009, the disclosure of which is incorporated by reference.

### FIELD

The present disclosure relates to swimming pools, and more particularly, to an accessory system for accessing the skimmer portion of a swimming pool.

### BACKGROUND

Swimming pools are of great value for recreational and fitness purposes, as they allow persons to swim for exercise, lounge and float therein for fun, and to cool off in warm weather conditions and climates. Pools that are situated outdoors are especially advantageous in such warm weather conditions and climates.

To enjoy and safely use a swimming pool, a sanitary environment in the pool itself is preferable. Users may introduce a chlorine or bromine-based solution to pool water to neutralize microscopic contaminants in the water. A pool may also include a filtration system, which circulates and flushes water within and from the pool. Such filtration systems typically include at least a water pump, a filter unit, a skimmer, and a water return. In the operation of a typical filtration system, solid debris (such as leaves, insects, trash, and the like) will be guided toward the water return. To prevent the debris from entering the return, the skimmer collects the debris.

The skimmer may be a basket-shaped container with a plurality of apertures, which apertures are preferably large enough to permit water but not solid objects to pass therethrough. When the filtration system directs pool water (and debris therein) to the water return, the skimmer retains the debris while allowing the water to flow through to the return.

Pool water usually enters the skimmer through an opening on a sidewall of the pool. The skimmer may sit in a chamber on the other side of the sidewall, which chamber will include a drain that leads to the water return. The chamber may also include a closable cover that allows a user to insert and remove the skimmer from chamber. The skimmer may also include a handle attached to a top section of the skimmer, to assist the user in lifting The cover allows the chamber to be covered and closed to prevent items from the deck that surrounds the pool from falling therein, and to prevent users from tripping on falling (even partially) into the chamber. The cover will sit flush with the pool deck in when in its chamber covering position.

To access the skimmer, a user may remove the cover first. Often, the cover will include at least one access aperture that permits a user to obtain leverage for removing the cover from the chamber. In such an instance, the user must insert his or her finger, fingers, or entire hand into the aperture to be able to pry the cover off of the chamber, so that the skimmer can be accessed.

There are a number of difficulties associated with the cover arrangement mentioned above. For instance, a user is required to bend down to access the aperture for removing the cover. Where a user has back problems or other physical ailments, this will make accessing and removing the cover a painful task. Irrespective of a user's physical condition, the act of prying and replacing the cover on the chamber is a cumbersome task.

Another issue with traditional cover arrangements relate to the fact that covers are usually of an opaque material, such that the user cannot see beneath them and cannot discern whether there are any potentially harmful or dangerous items under the cover and in the skimmer. Because the user has to bend down and place him or herself in very close proximity of the skimmer and chamber when removing the cover, he or she places himself in imminent danger in the event that a wasp, hornet, scorpion, or other dangerous insect or animal has made its way under the cover. In such a case, the user will not be aware of such danger until the opaque cover is removed by the user, and the user may not have time to remove him or herself until after he or she has been stung or bitten by a dangerous insect or animal.

Accordingly, there exists a need for an apparatus capable of reducing or eliminating injuries and harm associated with removing a pool skimmer cover and retrieving a skimmer from a pool. There also exists a need to reduce the cumbersome quality of removing and replacing a skimmer cover on a chamber.

### SUMMARY

It is an object of the present disclosure to obviate above and other disadvantages from existing art and to provide for a pool skimmer accessory system that overcomes all of the disadvantages of the prior art, while still maintaining the advantages of the prior art.

It is accordingly an object of the present to provide for a pool skimmer accessory system that facilitates the removal and replacement of a skimmer cover, as well as the retrieval of a skimmer from the skimmer chamber.

It is also an object of the present disclosure to provide for preventing injuries to a person associated with manual access of a skimmer and skimmer cover by a person.

It is further an object of the present disclosure to provide for a skimmer accessory that is lightweight, resilient, and easy to manufacture.

### BRIEF DESCRIPTION OF THE DRAWING

FIG. 1 is a depiction of a pool skimmer accessory system, in accordance with an exemplary embodiment of the present disclosure,

### DETAILED DESCRIPTION

The best mode for carrying out the disclosure is presented in terms of its preferred embodiment, herein depicted in the accompanying FIGURE. The preferred embodiments described here in detail for illustrative purposes are subject to many variations. It is understood that various omissions, substitutions of equivalents are contemplated as circumstances may suggest or render expedient, but is intended to cover the application or implementation without departing from the spirit or scope of the claims of the present disclosure. As used herein, the terms “a” and “an” herein do not denote a limitation of quantity, but rather denote the presence of at least one of the referenced item.

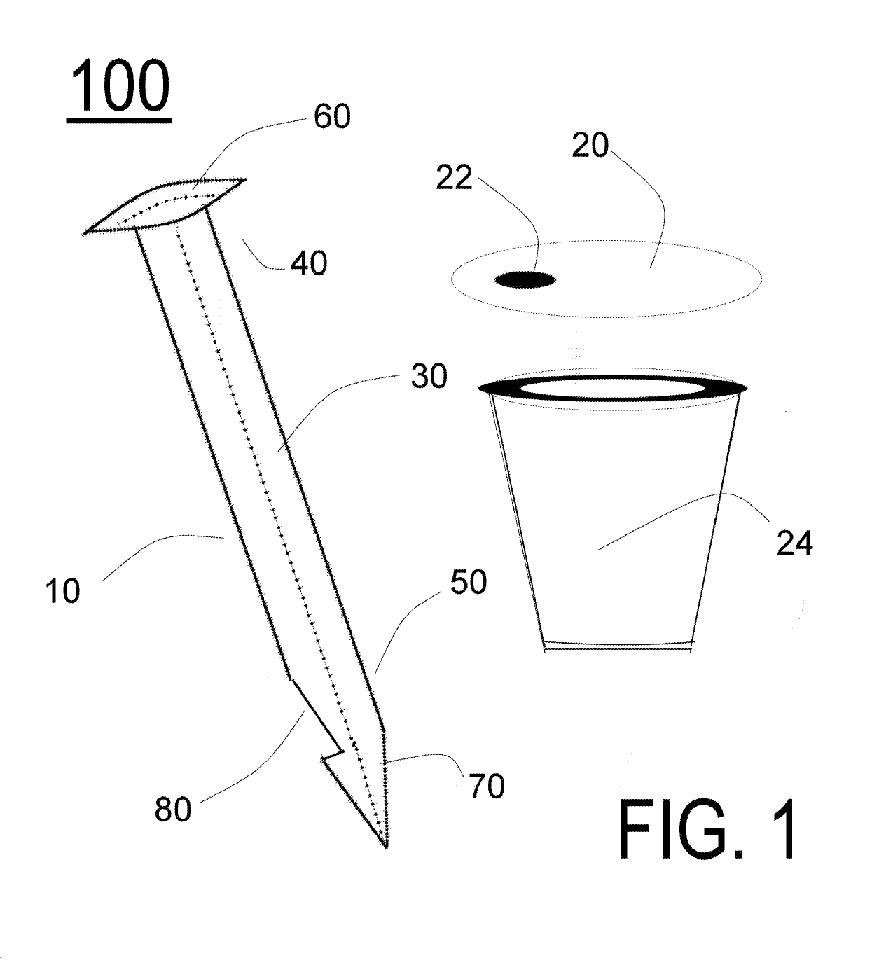

As shown in FIG. 1, the present disclosure provides for a pool skimmer accessory system 100. The system 100 comprises a skimmer accessory 10 (hereinafter, “skimmer accessory” or “accessory”) for enabling the removal and replacement of a pool skimmer cover 20 and retrieval of a skimmer 24 from a pool skimmer chamber. The system 100 also optionally provides a skimmer cover 20 that includes at least one aperture 22 for complementary engagement with the skimmer accessory 10.

The skimmer accessory 10 includes an elongate shaft member 30 with a first end 40 and a second end 50. A handle portion 60 is disposed at the first end 40 of the elongate shaft member 30, which handle portion 60 may be removably attached or formed as part of the first end of the elongate shaft member. The second end 40 of the elongate shaft member comprises a tapered region 70 of the shaft member 30, the taper of which tapered region 70 decreases the dimensions of the shaft member 30. Disposed in or adjacent to the tapered region 70 is a cut-out section 80, which cut-out section 80 may form a hook, notch, or shelf that extends toward the interior of the shaft member 30.

The skimmer accessory 10 may be formed from wood, durable plastic, lightweight metal, or metals or metal alloys, and may be coated appropriately to prevent corrosion or rotting of such materials. In an embodiment, the shaft member 30 may be four feet in length, however, one skilled in the art will understand that the shaft member 30 may be of other lengths, and that all dimensions provided herein are exemplary and should not be considered limiting. The shaft member 30 may have a circular, rectangular, or other similar cross sectional shape. In an embodiment, the cross-sectional dimension of the skimmer accessory 10 may be 1.5 inches. This dimension may vary, but should be such that the shaft member may freely pass through any apertures 22 of a skimmer cover 20.

At the tapered region 70 of the shaft member 30, the taper may begin approximately six inches from the end of the shaft member 30, and the taper may continue until the end of the shaft member 30 is reached and may be of such an orientation that the that the cross-sectional dimension of the shaft member 30 is decreased by a third at the end of the taper. The tapered region 70 further facilitates entry and exit of the accessory into and out of an aperture 22 of a skimmer cover 20.

In an embodiment, the taper of the tapered region 70 is limited to one side of the shaft member 30, in the case of a shaft member 30 with a rectangular cross-section. In the case of a shaft member 30 with a circular cross-section, the tapered section may be limited to half the diameter of the cross section. In such embodiments, a cut-out section 80 may be disposed within the shaft member 30 opposite the tapered region 70. The cut-out section 80 may be so configured to form a notch, a shelf, or a hook within the cut-out section 80. The cut-out section 80 may be configured such that the notch, shelf, or hook is disposed on the end of the cut-out section 80 that is proximate to the second end 50 of the elongate shaft member 20.

A handle portion 60 may be disposed on the first end 40 of the elongate shaft member 20 comprises a substantially straight and flat unit that is oriented perpendicularly with respect to the elongate shaft member 20 and that extends approximately two inches at either end away from the elongate shaft member 20. The handle portion 60 may be constructed from the same materials as the elongate member and may optionally feature a contoured surface to accommodate a user's hand. The handle portion 60 may also be covered in foam rubber or other soft or tacky material to improve a user's grip on the accessory. The handle section 60 may be fastened to the elongate shaft member 30 by way of screws, nails, a nut and bolt arrangement, or other similar mechanisms.

In use, to remove a skimmer cover and retrieve a skimmer from a chamber, the user may insert the tapered region of the accessory into an aperture of a skimmer cover and dispose the notch, shelf, or hook portion of the cut-out section against the underside of the skimmer cover to securely manipulate and remove the skimmer cover, such that the user may then view the skimmer itself before removing the skimmer from the skimmer chamber. The user may then set the cover aside and use the accessory, and particularly, the notch, shelf, or hook portion of the cut-out section to secure and lift the skimmer out of the chamber. In the event that the skimmer includes a handle thereon, the user may utilize the accessory to lift the skimmer by having the accessory secure the handle portion of the skimmer.

Alternatively, the user may insert the tapered region of the accessory through the aperture of a skimmer cover and dispose the notch, shelf, or hook portion of the cut-out section against the skimmer or skimmer handle directly, and then lift the skimmer out of the chamber, such that the cover is removed in the process of the skimmer being lifted out of the chamber. When the skimmer is ready to be replaced in the chamber, the user may use the accessory to lower the skimmer back into the chamber.

In the event that a user's existing skimmer does not include a cover with an aperture, the user may utilize the skimmer cover of the system disclosed herein as a replacement cover that may readily utilize the skimmer accessory.

The pool skimmer accessory system disclosed herein offers various advantages, including facilitating manipulation and placement of a pool skimmer and skimmer cover such that a user not required to bend down or over to reach the skimmer or cover. Further the accessory allows a user to remove a cover and access a skimmer from a distance such that the user is not directly subjected to debris or dangerous insects or animals that may be concealed under the skimmer cover, but may instead be distanced sufficiently from such debris, insects, or animals, such that the risks of danger and harm in accessing the skimmer are reduced significantly.

The foregoing descriptions of specific embodiments of the present disclosure have been presented for purposes of illustration and description. They are not intended to be exhaustive or to limit the disclosure to the precise forms disclosed, and obviously many modifications and variations are possible in light of the above teaching. The exemplary embodiment was chosen and described in order to best explain the principles of the disclosure and its practical application, to thereby enable others skilled in the art to best utilize the disclosure and various embodiments with various modifications as are suited to the particular use contemplated.

What is claimed is:

1. A pool skimmer accessory system, the system comprising a skimmer accessory and a skimmer cover, the skimmer accessory comprising
an elongate shaft member with a first end and a second end, wherein
a handle portion is disposed at the first end of the elongate shaft member,
a tapered region is disposed at the second end of the elongate shaft member, and
a cut-out section is disposed on the elongate shaft, and
wherein the skimmer cover comprises at least one aperture therein.

2. The system of claim 1, wherein said handle portion is removably attached to said first end of said elongate shaft member.

3. The system of claim 1, wherein said cut-out section is in the shape of a hook.

4. The system of claim 1, wherein said cut-out section is in the shape of a notch.

5. The system of claim 1, wherein said cut-out section is in the shape of a shelf.

6. The system of claim 1, wherein the skimmer accessory is formed of durable plastic.

7. The system of claim 1, wherein the skimmer accessory has a rectangular cross-section.

8. The system of claim 7, wherein the tapered region is disposed on one-half of the cross-section of the second end.

9. The system of claim 1, wherein the skimmer accessory has a circular cross-section.

10. The system of claim 9, wherein the tapered region is disposed on one-half of the cross-section of the second end.

11. The system of claim 1, wherein the handle portion is coated in foam rubber.

12. A skimmer accessory for removing accessing the skimmer of a pool, the accessory comprising
an elongate shaft member with a first end and a second end, wherein
a handle portion is disposed at the first end of the elongate shaft member,
a tapered region is disposed at the second end of the elongate shaft member, and
a cut-out section is disposed in the elongate shaft.

13. The accessory of claim 12, wherein said handle portion is removably attached to said first end of said elongate shaft member.

14. The accessory of claim 12, wherein said cut-out section is in the shape of one of a hook, a notch, and a shelf.

15. The accessory of claim 12, wherein the elongate shaft member has a rectangular cross-section.

16. The accessory of claim 12, wherein the tapered region is disposed on one-half of the cross-section of the second end.

17. The accessory of claim 12, wherein the elongate shaft member has a circular cross-section.

18. The accessory of claim 12, wherein the tapered region is disposed on one-half of the cross-section of the second end.

19. The accessory of claim 12, wherein the handle portion is coated in foam rubber.
